(19) United States
(12) Patent Application Publication
(10) Pub. No.: US 2021/0406875 A1
(43) Pub. Date: Dec. 30, 2021

(54) METHOD AND APPARATUS FOR AUTOMATIC ADJUSTMENT MERCHANT PAYMENT

(71) Applicant: CARDFLIGHT, INC., NEW YORK, NY (US)

(72) Inventors: DEREK WEBSTER, NEW YORK, NY (US); Juan Ignacio Serra, Brooklyn, NY (US)

(73) Assignee: CARDFLIGHT, INC., NEW YORK, NY (US)

(21) Appl. No.: 17/361,933

(22) Filed: Jun. 29, 2021

Related U.S. Application Data
(60) Provisional application No. 63/045,497, filed on Jun. 29, 2020.

(51) Int. Cl. G06Q 20/38; G06Q 20/10

(52) U.S. Cl. CPC G06Q 20/387; G06Q 20/102

(57) ABSTRACT

A method and apparatus for providing an automatic adjustment solution including both upward and downward adjustments that can be applied to both cash and credit, includes determining, via a processor, a transaction amount and tender type. The processor determines a plurality of parameters using at least the tender type and receives data relating to the plurality of parameters. The processor is further configured to calculate the automatic adjustment based on the plurality of parameters, apply the automatic adjustment to the transaction amount, and process a transaction based on the automatic adjustment applied.

### CROSS REFERENCE TO RELATED APPLICATIONS

This application claims the benefit of U.S. Provisional Application Ser. No. 63/045,497, filed Jun. 29, 2020, the contents of which are incorporated herein as if fully set forth.

### FIELD OF INVENTION

The present disclosure relates to electronic payment and in particular to an automatic adjustment payment method.

### BACKGROUND

Merchants everywhere draw in new and existing customers by offering cash discounts as well as sales. Similarly, when a customer chooses to pay with a credit card an additional fee may need to be added as the cash discount does not apply. In the past, a merchant might have to enter the increase or decrease in sales total for each and every sales transaction which takes valuable time away from other key responsibilities. The advent of electronic devices that have significant functionality and connectability, a smartphone, tablet, or other device, can be equipped to take credit card, as well as cash, payments conveniently. Mobile merchants, therefore, utilize a reseller, who provides them with an application to accept swiped, dipped or tapped depending on whether it's magnetic stripe, EMV chip card, or contactless tap-to-pay (e.g. Apple Pay) credit card payments that are processed by a credit card processor.

Modern systems only allow for an upward or downward adjustment. For example, a merchant advertises lower price for a product (the “cash price”) and customers are charged more if they pay with card. The lower/cash price is typically the same price a merchant historically charged for the goods/services in question. The increased fee for card and other non-cash tender types can be labelled on a receipt in a variety of ways including “Non-Cash Adjustment” and “Pay with Cash and Save”, for example. Additionally, merchants may have an increased fee for any type of payment. For example, restaurants often charge large parties an additional fee. Alternatively, the merchant advertises new, higher prices for products and customers are charged less (typically same as old prices) if they pay with cash. Resellers work with merchants to raise product prices, offering a discount back to previous pricing levels if customer pays cash. Further, these systems can only apply to adjustment to one type of tender, either cash or credit.

### SUMMARY

A method and apparatus for providing an automatic adjustment solution including both upward and/or downward adjustments that can be applied to both cash and credit. A method for providing an automatic adjustment solution including both upward and downward adjustments that can be applied to both cash and credit, includes determining, via a processor, a transaction amount and tender type. The processor determines a plurality of parameters using at least the tender type and receives data relating to the plurality of parameters. The processor is further configured to calculate the automatic adjustment based on the plurality of parameters, apply the automatic adjustment to the transaction amount, and process a transaction based on the automatic adjustment applied.

An apparatus for providing an automatic adjustment solution comprising an input/output driver, a memory, and a processor communicatively coupled to the input/output driver and the memory. The processor is configured to determine a transaction amount and a tender type from the input/output driver, determine a plurality of parameters using at least the tender type. The processor is further configured to receive data from the input/output driver relating to the plurality of parameters, calculate the automatic adjustment based on the plurality of parameters, apply the automatic adjustment to the transaction amount, and process a transaction based on the automatic adjustment applied.

According to the present invention, it is possible to provide upward adjustments to both cash and credit separately or simultaneously, as well as downward adjustments to both case and credit separately or simultaneously, which allows for an improvement in processing and transaction times.

### BRIEF DESCRIPTION OF THE DRAWINGS

FIG. 1 is a schematic diagram of an example system for providing merchant services.

FIG. 2 is a schematic block diagram of an example wireless device operating in the example system of FIG. 1.

FIG. 3 is a schematic block diagram of an example server operating in the example system of FIG. 1;

FIG. 4 is a flowchart for determining automatic adjustments at a mobile merchant.

FIG. 5A is an example screen for creating automatic adjustments.

FIG. 5B is an example of the automatic adjustment screen as seen by merchants.

FIG. 6A is an example screen for selecting a tender type according to FIG. 1.

FIG. 6B is an example screen for applying an upward automatic adjustment requiring merchant approval.

FIG. 7 is a schematic diagram of an example system for applying a downward automatic adjustment.

FIG. 8 is a schematic diagram of a different example system for applying a downward automatic adjustment.

FIG. 9 is an example of a reporting screen including a merchant's automatic adjustments.

FIG. 10 is an example of a merchant's input screen.

FIG. 11 is an example of a transaction on a merchant's input screen including cash downward automatic adjustment applied before sales tax.

FIG. 12 is an example of a transaction on a merchant's input screen including cash downward automatic adjustment applied after sales tax.

FIG. 13 is an example of a transaction on a merchant's input screen including a cash and credit downward automatic adjustment applied before sales tax.

### DETAILED DESCRIPTION OF THE PREFERRED EMBODIMENTS

The following description is intended to convey an understanding of the invention by providing a number of specific embodiments. It is understood, however, that the invention is not limited to these exemplary embodiments and details.

Provided is a method and system that allows, for example, a mobile merchant, in-store merchant and any merchant with a merchant terminal to automatically adjust purchases based on their own needs. Further, the method and system allow for simultaneous upward and downward adjustments to both cash and credit tender.

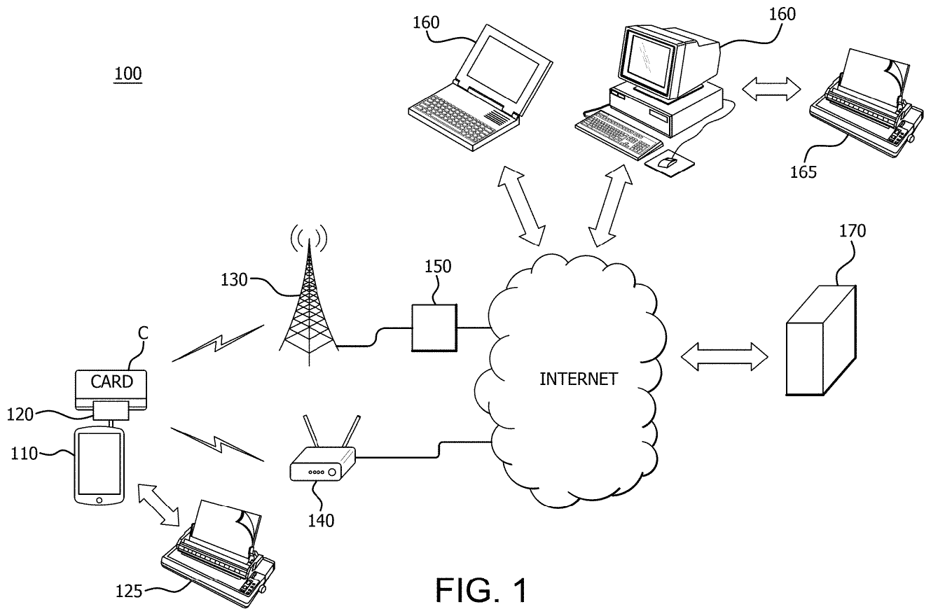

FIG. 1 is a schematic diagram of an example system 100 for providing merchant services. The system 100 includes a wireless device 110, including an electronic card reader 120 configured to read, for example, a credit/debit card C. The wireless device 110 may be in wireless communication with a cellular base station 130 and/or a wireless router 140 for connection to the Internet to transmit and receive data. Additionally, a printer 125 may be in communication with the wireless device 110 in order to receive printouts. The base station 130 may be connected to the Internet via a Core Network 150, (e.g., Radio Network Controller, Gateway, or the like), or any other connection scheme. Similarly, the wireless router 140 may be connected to the Internet via any connection. The system also includes one or more reseller devices 160 and a provider server 170, all of which are also connected to the Internet by any type of connection. A printer 165 may be in communication with the one or more reseller devices 160 in order to receive printouts.

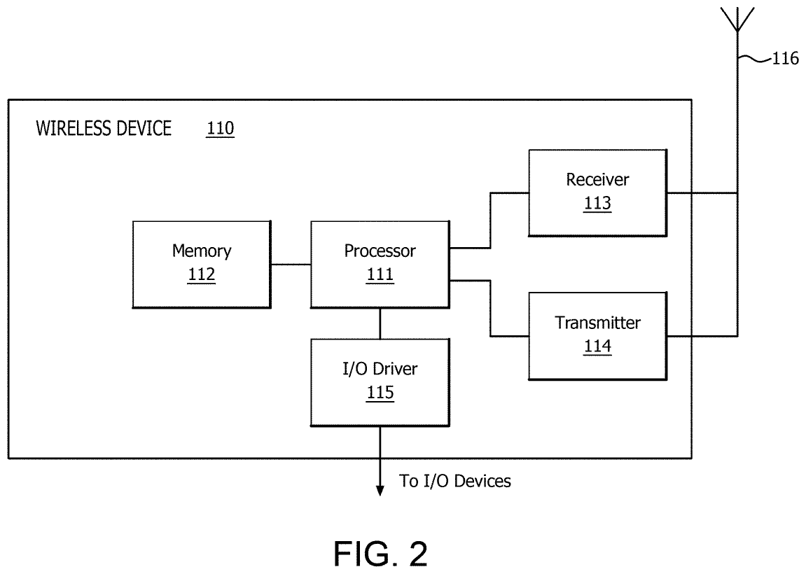

FIG. 2 is a schematic block diagram of an example wireless device 110 operating in the example system 100 of FIG. 1. The wireless device 110 includes a processor 111, a memory 112 in communication with the processor 111, a receiver 113 in communication with the processor 111, a transmitter 114 in communication with the processor 111, an Input/Output Device Driver (I/O driver) 115 in communication with the processor 111, and an antenna 116 in communication with the receiver 113 and the transmitter 114. The processor 111 is configured to receive data from the I/O driver 115, as well as to receive and send data to the memory 112. The processor 111 is further configured to control receive data from the receiver 113 via the antenna 116, and to control the transmitter 114 to transmit data wireless via antenna 116. The I/O driver 115 is configured to be connected to, for example, the electronic card reader 120. The connection may include one or more of a USB port, audio jack connection, Bluetooth connection, or other connection.

The processor 111 is further configured to receive inputs from a merchant (not shown). The merchant is able to configure types of sales, tender types, and output configurations. Additionally, when no input is received from the merchant, the processor 111 is configured to determine the types of sales, tender types, and output configurations.

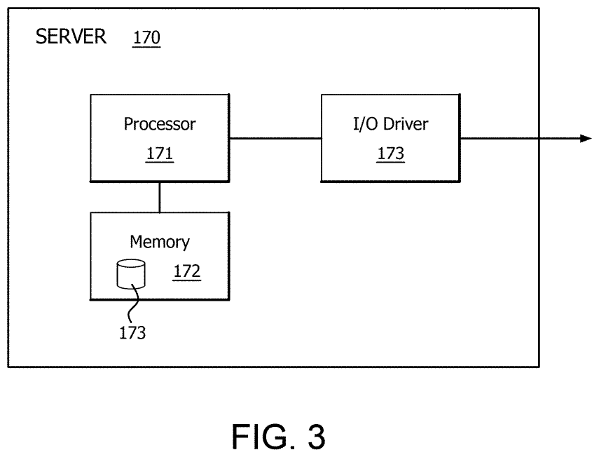

FIG. 3 is a schematic block diagram of an example server 170 operating in the example system 100 of FIG. 1. The sever 170 includes a processor 171, a memory 172 in communication with the processor 171, and an I/O driver 173 in communication with the processor. The memory 172 includes a database 173 for storing and extracting data. The I/O driver 173 transmits data to and receives data from the processor 171 for external transmission, (e.g., from and to the Internet). The server 170 may be utilized by a provider to provide merchant services via a reseller.

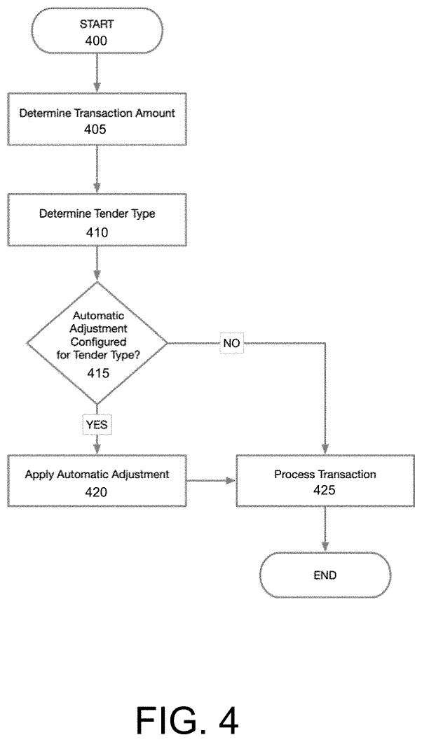

FIG. 4 is a flowchart of an example method for determining automatic adjustments at a mobile merchant. The mobile merchant can use a wireless transaction system to implement the method of FIG. 4. First in step 405, a total transaction amount is determined. Any number of methods can be used to determine the total transaction amount. Next in step 410, the merchant selects a tender type. In an exemplary embodiment, the transaction system can display multiple tender options including “cash” and “credit.” The merchant then selects the correct tender option. In a second exemplary embodiment the processor 111 determines the tender type by determining if a credit card is inserted into a card reader.

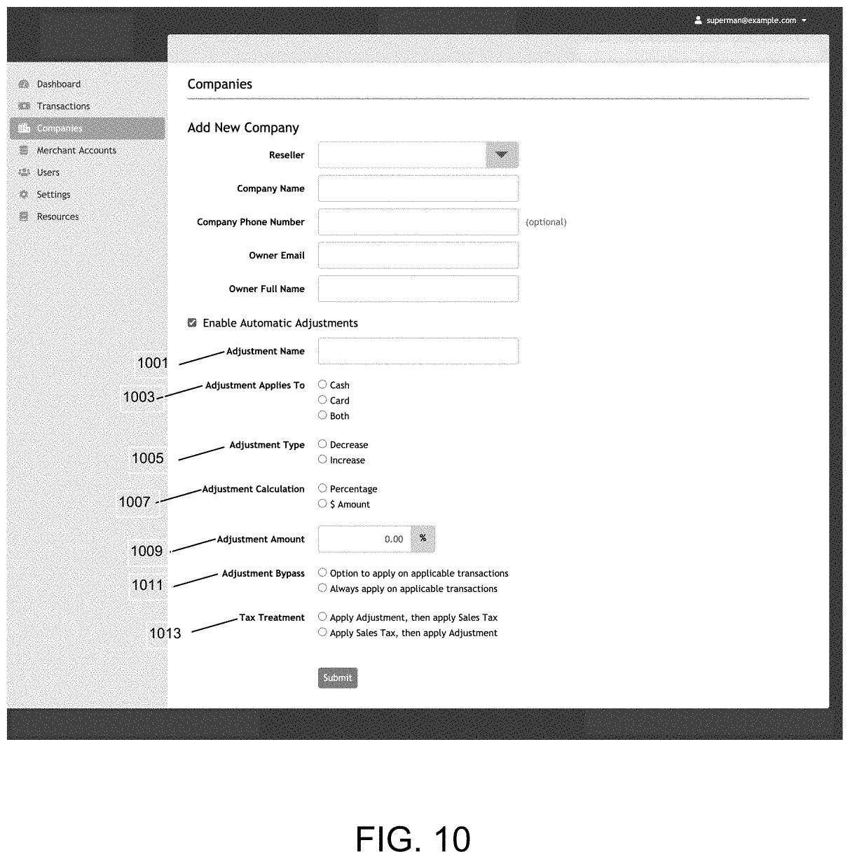

Once the tender type is selected in step 410, it is determined whether there is a configured automatic adjustment for the selected tender type, step 415. In an exemplary embodiment, the processor 111 determines a plurality of parameters. The processor 111 can use any number of factors to determine the parameters. For example, the processor 111 may determine the plurality of parameters using at least the transaction amount, the tender type, and merchant parameters. An exemplary example of parameters will be described later with respect to FIG. 10. The processor 111 then requests, via the I/O Driver 115, information regarding the determined parameters from the processor 171.

Once the processor 111 receives the information regarding the determined parameters from the processor 171, the processor 111 calculates an automatic adjustment. In an exemplary embodiment, the merchant inputs a plurality of information including the adjustment, what type of transaction that adjustment applies to, the adjustment type, and the adjustment calculation. The processor 111 then calculates the automatic adjustment based on the merchant inputs and the plurality of parameters. Based on this, it is possible to improve processing times using the plurality of parameters and/or the merchant information. In a different exemplary embodiment, it is possible for the processor 111 to determine if an automatic adjustment is available without requiring the merchant to input the plurality of parameters. For example, the processor 111 is able to determine from the purchase whether there is an automatic adjustment to be calculated into the transaction. Thus, it is possible to improve processing times and transaction times by allowing the processor to determine if an automatic adjustment is available without requiring a merchant to approve or select a specific adjustment.

When the selected tender type has a configured automatic adjustment, the system adjusts the total transaction amount based on the configured automatic adjustment in step 420. In one exemplary embodiment, when there is a configured automatic adjustment, the merchant is prompted to apply the adjustment. In a different exemplary embodiment, when there is a configured automatic adjustment, the system automatically adjusts the total transaction without the need for the merchant to accept the adjustment. The merchant can control which types of adjustments require merchant approval and which are automatically applied. Thus, it is possible with multiple types of adjustments that some are applied automatically while others require approval during the transaction. The process then proceeds to step 425.

Additionally, when the automatic adjustment is being applied in step 420, the system is able to determine a tax treatment of the adjustment. For example, in one embodiment, the automatic adjustment can be applied prior to sales tax. In a different exemplary embodiment, the processor 111 is able to determine and apply sales tax then apply the automatic adjustment.

For example, the total amount of a transaction may not change, but the allocation of amounts to various line items (tax, adjustment) in reporting and on the receipt may. By using a feature such as “apply adjustment, then apply sales tax”, for example, may treat the adjustment as being taxable, but may result in reconciliation issues between the total amount of credit card fees withheld by the reseller (a % of the total amount) and the total amount of adjustments reported (a % of the pre-tax amount)

By using an “apply sales tax, then apply adjustment” feature, for example, it may treat the adjustment as a gross up of both the pre-tax amount and sales tax. This may result in that the total amount of credit card fees withheld by the reseller (a % of the total amount) and the total amount of adjustments reported (a % of the total amount) matching one another.

When the selected tender type does not have a configured automatic adjustment, the system proceeds to step 425. In step 425, the transaction is processed and then the process ends. Thus, unlike conventional systems, the method of FIG. 4 is more efficient as the automatic adjustment is done in one step and can be applied to both upward and downward adjustments.

The method of FIG. 4 can be used on either a wireless or hardwired system, including a mobile device that runs either iOS or Android systems, as well as on a payment terminal device such as the A80 or A920.

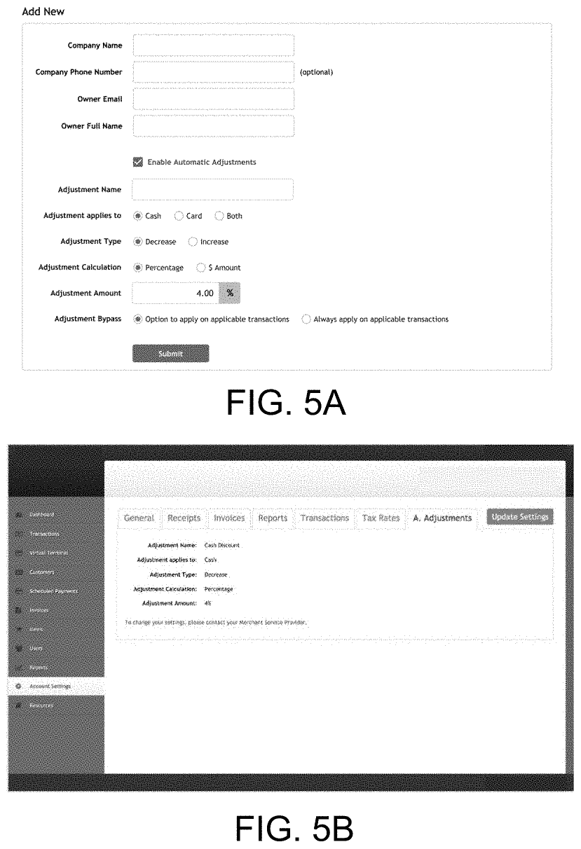

FIG. 5A shows an exemplary embodiment of a screen where the merchant can create automatic adjustments to be selected in step 415. As shown the administrator (e.g., reseller) can customize upfront the Name of the Adjustment, the Application of the Adjustment, the Adjustment Type, the Adjustment Calculation, the Adjustment Amount and the Adjustment Bypass. The Application of the Adjustment allows the merchant to determine if the adjust applies to cash, credit, or both types of transactions. While the Adjustment Type determines whether there is an upward or downward adjustment. The Adjustment Bypass is an option which allows either the adjustment to be automatically done or send an option to apply. When the “option to apply to applicable transactions” is selected for a specific adjustment type, the merchant is prompted to either apply to not to apply the adjustment at time of sale. Conversely, when the “always apply to applicable transactions” is selected, the adjustment is always added at time of sale. By allowing the administrator to set the parameters upfront, the method according to FIG. 4 is able to streamline the adjustment process and select the proper adjustment during step 415 to complete a sale. Thus, the automatic adjustments feature runs and either adjusts a transaction or leaves it unadjusted based on the parameters configured by the administrator. Additionally, merchants can “opt-in” to their administrators' program which allows the automatic adjustment of the administrator to be applied to the merchant's system accordingly.

FIG. 5B is an example of the automatic adjustment screen as seen by merchants. Based on the parameters set by the administrator, in FIG. 5A, the merchant then has access to the automatic adjustment screen which breaks down each adjustment.

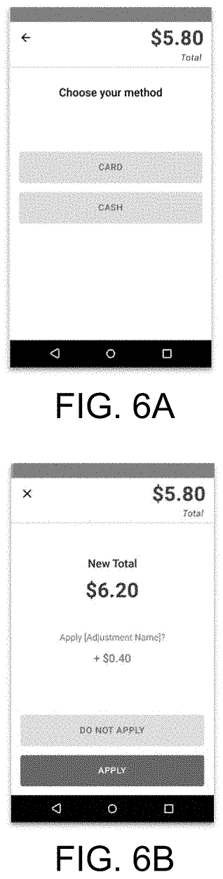

FIG. 6 shows a schematic diagram of an example system for applying an upward automatic adjustment which includes the “option to apply to applicable transactions” selection for the Adjustment Bypass. As shown in FIG. 6A, the merchant is prompted to select the tender type during the transaction (step 410). In this embodiment, the selection options include card or credit. However, in a different exemplary embodiment, not shown, a debit option can also be added. Once the merchant selects the tender type (step 410), the system determines whether an adjustment is configured for this type of transaction and a new screen appears. As shown in FIG. 6B, the new screen allows the merchant to select either “apply” or “do not apply” the adjustment.

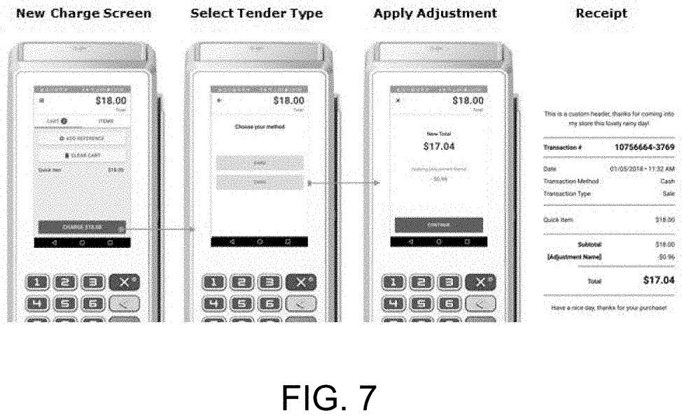

FIG. 7 is a schematic diagram of an example system for applying a downward automatic adjustment when the Adjustment Bypass is set to “always apply to applicable transactions.” As shown in the “New Charge Screen”, when the sale is totaled, the screen includes the option to “charge the total amount,” in this case $18.00. Next, in the “Select Tender Type” screen, the merchant is prompted to select tender type (step 410), which in this example includes either “cash” or “credit.” In this exemplary embodiment, the tender type selected is cash. The system then determines if there is a configured automatic adjustment for this type of transaction (step 415). Here, since there is configured automatic adjustment a new screen appears, the “Apply Adjustment” screen, and the new total, based on the applied automatic adjustment is shown, (step 420) and the sale is completed (step 425). If the tender selected during the transaction flow does not correspond to a configured automatic adjustment, then the merchant will continue through the flow as they normally would and no automatic adjustment will be applied to the transaction. Finally, as shown the receipt is created, and includes the original total, the transaction method, the name of the adjustment that was applied and the final total based on the configured adjustment.

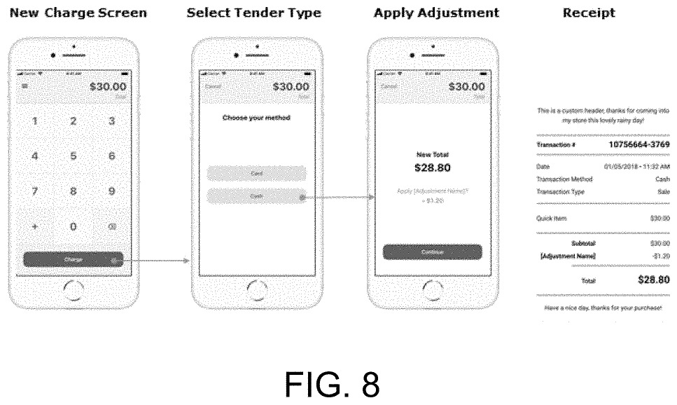

FIG. 8 is a schematic diagram of a different example system for applying a downward automatic adjustment when the Adjustment Bypass is set to “always apply to applicable transactions.” As shown in the “New Charge Screen”, when the merchant enters the total amount and this screen includes the option to “charge” the total amount, in this case $30.00. Next, in the “Select Tender Type” screen, the merchant is prompted to select tender type (step 410), which in this example includes either “cash” or “credit.” In this exemplary embodiment, the tender type selected is cash. The system then determines if there is a configured automatic adjustment for this type of transaction (step 415). Here, since there is configured automatic adjustment a new screen appears, the “Apply Adjustment” screen, and the new total, based on the applied automatic adjustment is shown (step 420), and the sale is completed (step 425). Finally, as shown the receipt is created, and includes the original total, the transaction method, the name of the adjustment that was applied and the final total based on the configured adjustment.

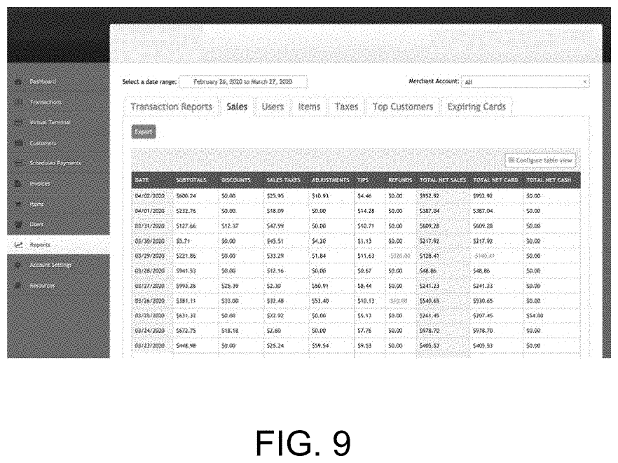

FIG. 9 is an example of a reporting screen including a merchant's automatic adjustments. As shown, Sales Reports can be updated regardless of whether the merchant has automatic adjustments enabled. The “Adjustments” table can be configured to only show up if is the merchant has automatic adjustments enabled. The Transaction Report Details, and the Daily Reports, will also be updated to contain details about Automatic Adjustments.

FIG. 10 is an example of a merchant's input screen including the parameters used to determine an automatic adjustment. As shown, a merchant can input specific information about their business including the business's name and contact information. This information allows for faster access by the processor 111 when determining if an automatic adjustment is available. Additionally, as shown in 1001 the merchant can name the automatic adjustment. The merchant has the option for the automatic adjustment to apply to cash, credit, or both tender types, 1003. In an exemplary embodiment, additional payment options such as check or money order can be added. The merchant then has the option to select a decrease or increase amount as the automatic adjustment type 1005. Next, the adjustment calculation can be selected 1007. In the exemplary embodiment, a merchant can select a percentage or dollar amount. The merchant then inputs the adjustment amount 1009. For example, a ten percent adjustment can be input. Then, the merchant selects whether this automatic adjustment is applied to all applicable transactions or if the adjustment is optional. For example, once step 415 is completed, prior to going to step 420, the merchant is given an option as to whether or not to apply the adjustment when the optional adjustment option is selected in FIG. 10 1011. This allows the merchant to bypass an automatic adjustment in certain scenarios. Thus, the present invention improves upon current systems by allowing merchants to determine when certain automatic adjustments are not needed. Finally, the merchant can select whether the automatic adjustment can be applied prior to or after sales tax 1013. Thus, it is possible to improve processing time as the automatic is adjustment is saved for future use. Additionally, the transaction time is also reduced.

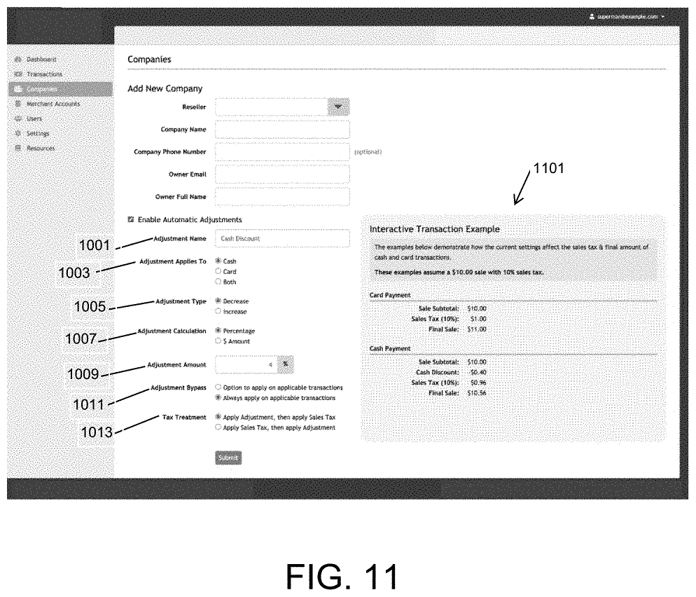

FIG. 11 is an exemplary embodiment of FIG. 10 wherein cash adjustments are made. As can be seen in 1003 the adjustment is applied to cash and the adjustment type 1005 is a decrease. Additionally, in this example, the merchant has selected a 4% amount, 1009, to be applied to all applicable transactions 1011. Finally, the merchant selected to apply the adjustment then the sales tax 1013. In box 1101, the screen shows the transaction had a card been used versus if cash is used. Here, it can be seen that payment with cash applies the 4% discount and further displays that the discount is applied before the sales tax.

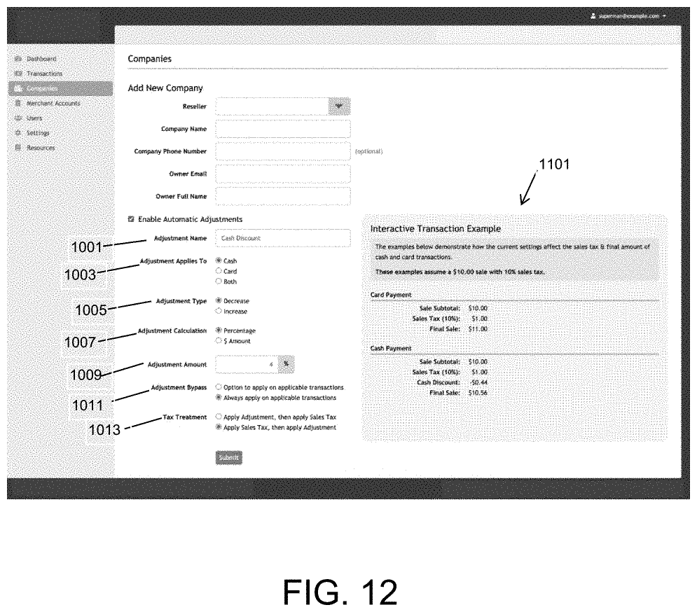

FIG. 12 is another exemplary embodiment of FIG. 10 wherein cash adjustments are made. FIG. 12 is similar to FIG. 11 in that a cash discount is offered. However, in this exemplary embodiment, the merchant selected to apply the sales tax then the adjustment 1013. In box 1101, the screen shows the transaction had a card been used versus if cash is used. Here, it can be seen that payment with cash applies the 4% discount and further displays that the discount is applied before the sales tax.

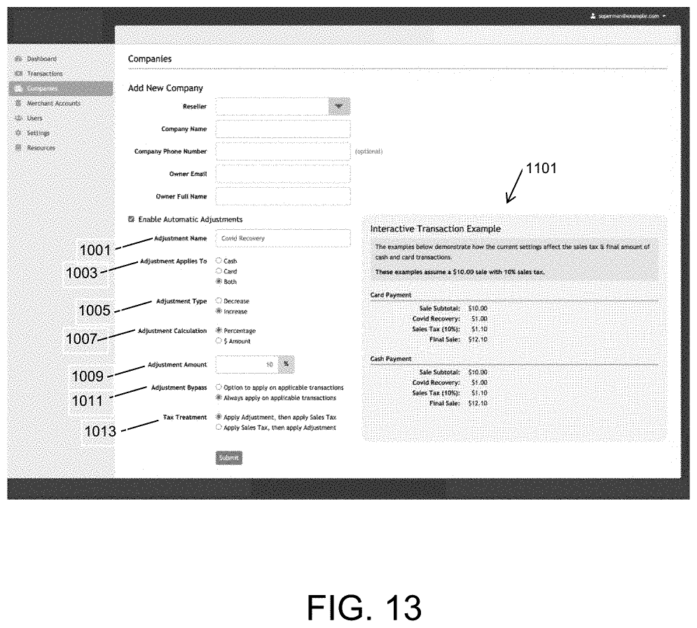

FIG. 13 is a different exemplary embodiment of FIG. 10 wherein multiple adjustments are made. As can be seen in 1003 the adjustment is applied to both cash and credit purchases. Here, the adjustment type 1005 is an increase. Additionally, in this example, the merchant has selected a 10% amount, 1009, to be applied to all applicable transactions 1011. Finally, the merchant selected to apply the adjustment then the sales tax 1013. In box 1101, the screen shows the transaction had a card been used versus if cash is used. Here, it can be seen that either form of payment applies the 10% amount and further displays that application before the sales tax.

Merchants will have the ability to apply an automatic increase or decrease of the sale total based on tender type. Further, with automatic adjustment the administrator has the ability to set up a discount to be automatically applied for cash transactions. This feature allows the administrator flexibility on how they handle certain tender types.

Additionally, if a merchant wants to adjust pricing across the board on either a permanent or temporary basis they could use the Automatic Adjustments feature so that their employees enter pre-adjusted prices. For example, this could be implemented during a seasonal sale.

The method or features described above can be implemented on a computer including at least a processor, a memory, an input/output device, a network and a display. Further, the method and features can take place between multiple computers that are in communication with each other.

Although features and elements are described above in particular combinations, one of ordinary skill in the art will appreciate that each feature or element can be used alone or in any combination with the other features and elements.

What is claimed is:

1. A method, implemented in a server, for providing automatic adjustments, comprising:
determining, via a processor, a transaction amount;
determining a tender type;
determining, via the processor, a plurality of parameters using at least the tender type;
receiving, by the processor, data relating to the plurality of parameters;
calculating, by the processor, the automatic adjustment based on the plurality of parameters;
applying the automatic adjustment to the transaction amount; and
processing a transaction based on the automatic adjustment applied.

2. The method according to claim 1, further comprising determining if one of a plurality of automatic adjustments is configured for the determined tender type.

3. The method according to claim 2, further comprising selecting one of the plurality of automatic adjustments and applying the selected automatic adjustment.

4. The method according to claim 3, further comprising determining whether to apply the selected automatic adjustment.

5. The method according to claim 1, further configured to apply upward adjustments or downward adjustments.

6. An apparatus, comprising:
an input/output (I/O) driver;
a memory; and
a processor communicatively coupled to the I/O driver and the memory, wherein the processor is configured to:
determine a transaction amount and a tender type from the I/O driver,
determine a plurality of parameters using at least the tender type;
receive data from the I/O driver relating to the plurality of parameters;
calculate the automatic adjustment based on the plurality of parameters;
apply the automatic adjustment to the transaction amount; and
process a transaction based on the automatic adjustment applied.

7. The apparatus of claim 6 wherein the processor is further configured to determine if one of a plurality of automatic adjustments is configured for the determined tender type.

8. The apparatus of claim 7 wherein the processor is further configured to select one of the plurality of automatic adjustments and apply the selected automatic adjustment.

9. The apparatus of claim 8 wherein the processor is further configured to determine whether or not to apply the selected automatic adjustment.

10. The apparatus of claim 6 wherein the processor is further configured to apply upward adjustments or downward adjustments.
